(19) United States
(12) Patent Application Publication
(10) Pub. No.: US 2026/0180857 A1
(43) Pub. Date: Jun. 25, 2026

(54) Period metric system

(71) Applicant: Mellanox Technologies, Ltd., Yokneam (IL)

(72) Inventors: Omer Shabtai, Tel Aviv (IL); Nevo Genossar, Tel Aviv (IL); Einav Zelig, Tel Aviv (IL); Matty Kadosh, Caesarea (IL); Ofek Barkai, Petah Tikva (IL); Alon Gal, Tel Aviv (IL); Adi Horowitz, Lehavot Habashan (IL)

(21) Appl. No.: 19/001,460

(22) Filed: Dec. 25, 2024

(51) Int. Cl. H04L 41/0823; H04L 41/16; H04L 43/0817

(52) U.S. Cl. CPC H04L 41/0823; H04L 41/0813; H04L 43/08; H04L 43/0817; H04L 43/20

(57) ABSTRACT

In one embodiment, a system for managing cloud infrastructure performance for cyclical workloads processed in a cloud infrastructure includes one or more processor to receive values of a period metric of the cyclical workloads based on data collected by network devices in the cloud infrastructure, and adjust at least one network device management parameter of at least one of the network devices based on the period metric values causing changes to the processing of the cyclical workloads in the cloud infrastructure, and memory to store data used by the at least one processor.

### FIELD OF THE DISCLOSURE

The present disclosure relates to computer systems, and in particular, but not exclusively to, cyclic processing.

### BACKGROUND

Cloud service providers (CSPs) offer infrastructure for customers to run workloads, for example, training artificial intelligence (AI) models. These AI training workloads typically involve large clusters of graphics processing units (GPUs) working together to process data in a cyclical manner. Each cycle or iteration involves a computation phase where the GPUs process data, followed by a communication phase where results are shared between GPUs over the network.

The performance of these AI training workloads depends on both the computational capabilities of the GPUs as well as the efficiency of the network connecting them. CSPs aim to optimize the performance of their infrastructure to provide the best experience for customers running these workloads.

### SUMMARY

There is provided in accordance with an embodiment of the present disclosure, a system for managing cloud infrastructure performance for cyclical workloads processed in a cloud infrastructure, the system including at least one processor to receive values of a period metric of the cyclical workloads based on data collected by network devices in the cloud infrastructure, and adjust at least one network device management parameter of at least one of the network devices based on the period metric values causing changes to the processing of the cyclical workloads in the cloud infrastructure, and memory to store data used by the at least one processor.

Further in accordance with an embodiment of the present disclosure the period metric is a cycle length between transmissions of data.

Still further in accordance with an embodiment of the present disclosure the at least one processor is to collect high-frequency telemetry (HFT) data from the network devices in the cloud infrastructure, and analyze the HFT data to extract the period metric values for the workloads.

Additionally in accordance with an embodiment of the present disclosure the HFT data includes packet flow information.

Moreover, in accordance with an embodiment of the present disclosure the HFT data is collected without accessing customer data or customer logs.

Further in accordance with an embodiment of the present disclosure the at least one processor is to generate an alert based on at least one of the extracted period metric values.

Still further in accordance with an embodiment of the present disclosure the at least one processor is to use the period metric values as input to a black box optimization process, adjust the at least one network device management parameter based on the black box optimization process, monitor the period metric to assess infrastructure performance, and iteratively adjust the at least one network device management parameter based on the monitoring of the period metric and the black box optimization.

Additionally in accordance with an embodiment of the present disclosure the at least one network device management parameter includes any one or more of the following adaptive routing configurations, congestion control settings, or Quality of Service (QOS) priorities.

Moreover, in accordance with an embodiment of the present disclosure the at least one processor is to detect anomalies or underperforming hardware based on the values of the period metric.

Further in accordance with an embodiment of the present disclosure the at least one processor is to exclude the underperforming hardware from future processing of the cyclic workloads.

Still further in accordance with an embodiment of the present disclosure the cyclical workloads are artificial intelligence (AI) training workloads.

Additionally in accordance with an embodiment of the present disclosure the network devices include network switches.

There is also provided in accordance with another embodiment of the present disclosure a system for managing cloud infrastructure processing cyclical workloads, the system including at least one processor to collect high-frequency telemetry (HFT) data from network devices in the cloud infrastructure, and analyze the HFT data to extract values of a period metric for the workloads, and a memory to store data used by the at least one processor.

Moreover, in accordance with an embodiment of the present disclosure the period metric is a cycle length between transmissions of data.

Further in accordance with an embodiment of the present disclosure the at least one processor is to generate an alert based on at least one of the extracted period metric values.

Still further in accordance with an embodiment of the present disclosure the HFT data includes packet flow information.

Additionally in accordance with an embodiment of the present disclosure the HFT data is collected without accessing customer data or customer logs.

Moreover in accordance with an embodiment of the present disclosure the at least one processor is to use the period metric values as input to a black box optimization process, adjust at least one network device management parameter based on the black box optimization process, monitor the period metric to assess infrastructure performance, and iteratively adjust the at least one network device management parameter based on the monitoring of the period metric and the black box optimization.

Further in accordance with an embodiment of the present disclosure the at least one network device management parameter includes any one or more of the following adaptive routing configurations, congestion control settings, or Quality of Service (QOS) priorities.

Still further in accordance with an embodiment of the present disclosure the at least one processor is to detect anomalies or underperforming hardware based on the values of the period metric.

Additionally in accordance with an embodiment of the present disclosure the at least one processor is to exclude the underperforming hardware from future processing of the cyclic workloads.

Moreover, in accordance with an embodiment of the present disclosure the cyclical workloads are artificial intelligence (AI) training workloads. Further in accordance with an embodiment of the present disclosure the network devices include network switches.

There is also provided in accordance with still another embodiment of the present disclosure a method for managing cloud infrastructure performance for cyclical workloads processed in a cloud infrastructure, the method including receiving values of a period metric of the cyclical workloads based on data collected by network devices in the cloud infrastructure, and adjusting at least one network device management parameter of at least one of the network devices based on the period metric values causing changes to the processing of the cyclical workloads in the cloud infrastructure.

There is also provided in accordance with still another embodiment of the present disclosure a method for managing cloud infrastructure processing cyclical workloads, the method including collecting high-frequency telemetry (HFT) data from network devices in the cloud infrastructure, and analyzing the HFT data to extract values of a period metric for the workloads.

### BRIEF DESCRIPTION OF THE DRAWINGS

The present disclosure will be understood from the following detailed description, taken in conjunction with the drawings in which:

FIG. 1 is a block diagram view of a computing system, e.g., a data center or a High-Performance Computing (HPC) cluster, in accordance with an embodiment of the present disclosure;

FIGS. 2 and 3 are block diagram views of a cloud management system constructed and operative in accordance with an embodiment of the present disclosure;

FIG. 4 is a flowchart including steps in a period metric extraction method for use in the system of FIG. 2; and

FIG. 5 is a flowchart including steps in a network device management parameter optimization method for use in the system of FIG. 2.

### DESCRIPTION OF EXAMPLE EMBODIMENTS

### Overview

A key challenge for CSPs is that they do not have direct visibility into the details or performance metrics (e.g., cycle time) of the customer workloads running on the CSP infrastructure. The workload data and logs belong to the customers and are not accessible to the CSP. This creates difficulties in understanding how well the infrastructure is performing for specific workloads and identifying opportunities for optimization.

Additionally, the cyclical nature of AI training workloads creates unique traffic patterns on the network that are not easily addressed by traditional network optimization approaches. The alternating computation and communication phases can lead to periods of network congestion followed by periods of low utilization.

For example, if two different AI jobs are being processed by the CSP at the same time, and the two AI jobs are trying to send packets at the same time, congestion may lead to packets being buffered and not sent. This leads to longer cycle times. If the AI jobs are managed correctly, e.g., by using priorities, then congestion may be reduced, and cycle time may be reduced. However, to manage the AI jobs correctly the cycle time needs to be visible.

Without insight into the workload characteristics and performance, CSPs are limited in their ability to tune network parameters and optimize infrastructure for these cyclical AI training jobs. This can result in suboptimal performance and inefficient resource utilization.

Embodiments of the present disclosure address at least some of the above drawbacks by providing a system and method for CSPs to gain insight into workload performance and optimize infrastructure without requiring access to customer data or logs. The system and method includes collecting high-frequency telemetry (HFT) data from network devices like switches to gather information on packet flows and network utilization, e.g., by counting packets associated with timing data for the different tenants'workloads. This telemetry data is then analyzed using specialized algorithms to extract the cycle time of workloads running on the infrastructure (e.g., based on timing of telemetry data). The extracted cycle time serves as a workload-aware metric that captures the characteristics of cyclical AI training jobs, providing valuable insight into the behavior of these workloads without accessing sensitive customer information.

Embodiments of the present disclosure are useful for any workloads which are cyclical and processed by devices in parallel and data relating to the workloads is shared over the network in parallel. In AI workloads the cycle time is called step time.

A cyclic workload is a workload which exhibits periodic or cyclic behavior such that every step time or period or cycle of the cyclic workload data is processed by processors across the network and data is sent over the network such that the cycle time is based on processing time (e.g., CPU or GPU time) plus network traffic time. In some cases, one or more given processors may complete data processing in a given cycle before other processors of the cyclic workload, and the given processor(s) may wait in an idle state until the other processors complete data processing before data is sent over the network by all the processors.

In some embodiments, the extracted cycle time becomes a key input to a black box optimization process that tunes one or more network parameters. These parameters may include adaptive routing configurations of network switches, which determine how packets are routed through the network; congestion control settings, which manage network traffic to prevent overload; and Quality of Service (QoS) priorities, which allocate network resources based on the importance of different traffic types. The optimization process uses the cycle time to evaluate the impact of parameter changes on workload performance (measured by the cycle time), allowing for iterative improvements. For example, giving priority to one AI job over another may result in reduced cycle times for both jobs. By observing changes in the cycle time, the system can detect when parameter adjustments have a positive or negative impact on workload efficiency. This allows for dynamic, workload-aware tuning of the network infrastructure to better support the unique traffic patterns of AI training jobs.

In some embodiments, the cycle times are analyzed to identify anomalies or underperforming hardware, such as “sick GPUs” that may be slowing down the overall AI training process or other cyclic workload. By analyzing the cycle time across different nodes in the cluster, outliers that consistently contribute to longer cycle times could be detected and flagged for further investigation, or potential replacement, or exclusion from future workloads.

Embodiments of the present disclosure operate at the infrastructure level, without requiring any changes or cooperation from the customers running the workloads and allowing CSPs to improve infrastructure utilization and customer experience transparently, enhancing their ability to support the growing demand for AI and machine learning infrastructure in the cloud. By providing a workload-aware optimization approach, embodiments of the present disclosure enable CSPs to offer more efficient and performant services for computationally intensive, cyclical workloads like AI model training.

### System Description

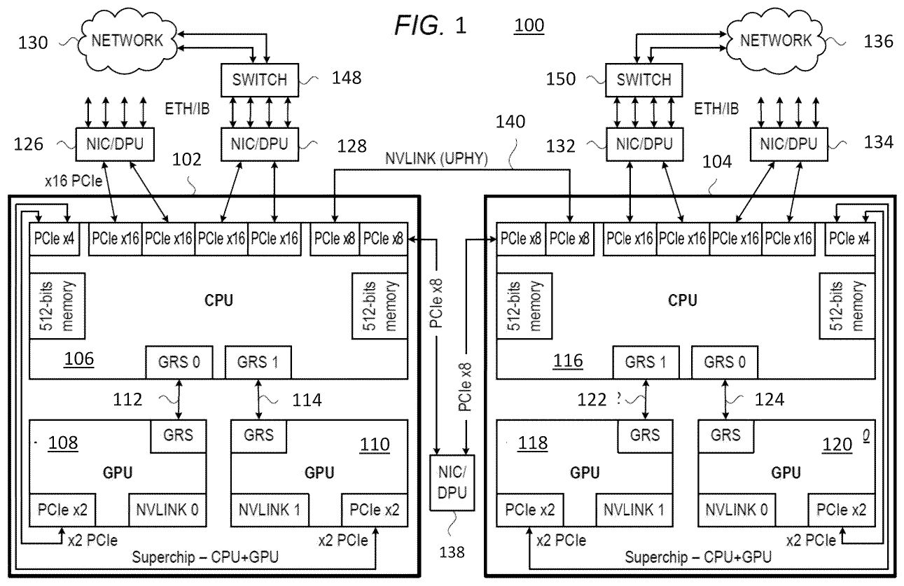

Reference is now made to FIG. 1, which is a block diagram that schematically illustrates a computing system 100, e.g., a data center or a High-Performance Computing (HPC) cluster, in accordance with an embodiment of the present disclosure.

System 100 comprises a plurality of subsystems, e.g., multiple processing devices coupled to each other, multiple network devices, and multiple networks, according to at least one embodiment. Computing system 100 is designed with multiple integrated circuits (referred to as processing devices), where each integrated circuit can include one or more central processing units (CPUs) and graphics processing units (GPUs), forming a powerful and flexible architecture.

The various processing devices are interconnected via an NVLink or other high-speed interconnect, enabling high-speed communication between the subsystems, and are also connected through a network interface controller (NIC) or data processing unit (DPU) to ensure efficient data transfer across computing system 100 and to one or more external networks 130, 136. In the present example, system 100 comprises a packet switch 148 that connects NIC/DPU 128 to network 130, and a packet switch 150 that connects NIC/DPU 132 to network 136.

The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 100 can include one or more CPUs and one or more GPUs.

FIG. 1 also demonstrates an example architecture of a multi-GPU architecture. As illustrated in the figure, computing system 100 includes a processing device 102 with a multi-GPU architecture. In particular, processing device 102 may be a system-on-chip and includes multiple subsystems such as a CPU 106, a GPU 108, and a GPU 110. CPU 106 can be coupled to GPU 108 via a die-to-die (D2D) or chip-to-chip (C2C) interconnect 112, such as a Ground-Referenced Signaling interconnect (GRS interconnect). CPU 106 can be coupled to GPU 110 via a D2D or C2C interconnect 114. CPU 106 can also couple to GPU 108 and GPU 110 via PCIe interconnects.

CPU 106 can be coupled to one or more NICs or DPUs, which are coupled to one or more networks. For example, as illustrated in FIG. 1, CPU 106 is coupled to a first NIC/DPU 126, which is coupled to a network 130. CPU 106 is also coupled to a second NIC/DPU 128, which is coupled to network 130 via switch 148. NIC/DPU 126 and NIC/DPU 128 can be coupled to network 130 over Ethernet (ETH), NVLINK or InfiniBand (IB) connections, for example.

Computing system 100 also includes a processing device 104 with a multi-GPU architecture. In particular, processing device 104 includes multiple subsystems including a CPU 116, a GPU 118, and a GPU 120. CPU 116 can be coupled to GPU 118 via a D2D or C2C interconnect 122. CPU 116 can be coupled to GPU 120 via a D2D or C2C interconnect 124. CPU 116 can also couple to GPU 118 and GPU 120 via PCIe interconnects. CPU 116 can be coupled to one or more NICs or DPUs, which are coupled to one or more networks. For example, as illustrated in FIG. 1, CPU 116 is coupled to a first NIC/DPU 132, which is coupled to a network 136. CPU 116 is also coupled to a second NIC/DPU 134, which is coupled to network 136 via switch 150. NIC/DPU 132 and NIC/DPU 134 can be coupled to network 136 over Ethernet (ETH), NVLINK or InfiniBand (IB) connections.

In at least one embodiment, processing device 102 and processing device 104 can communicate with each other via a NIC/DPU 138, such as over PCIe interconnects. Processing device 102 and processing device 104 can also communicate with each other over a high-bandwidth communication interconnect 140, such as an NVLink interconnect or other high-speed interconnects. The packet switches in FIG. 1 may comprise, for example, Nvidia Quantum-2 switches. The NICs/DPUs in the figure may comprise, for example, Nvidia Bluefield DPUs.

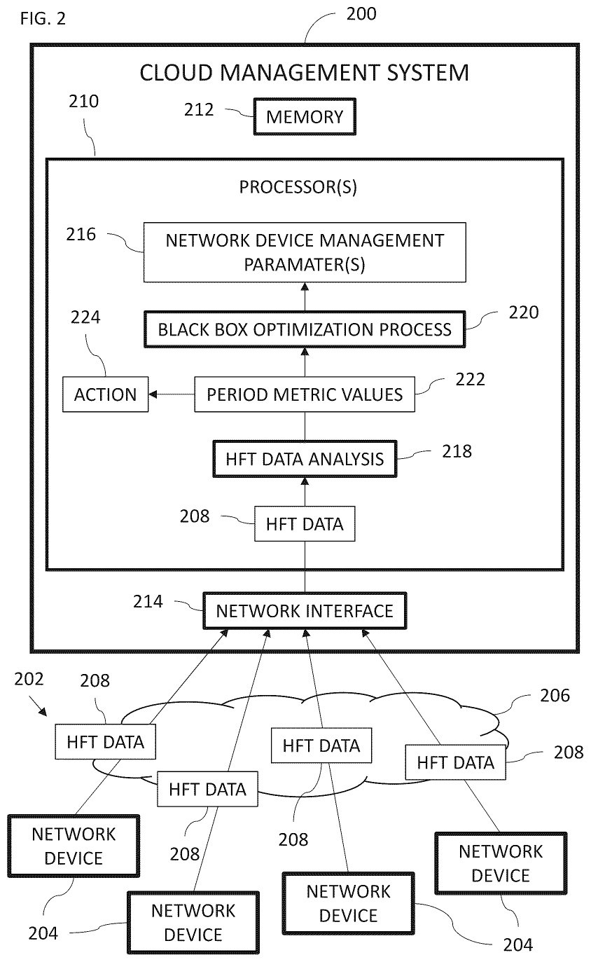

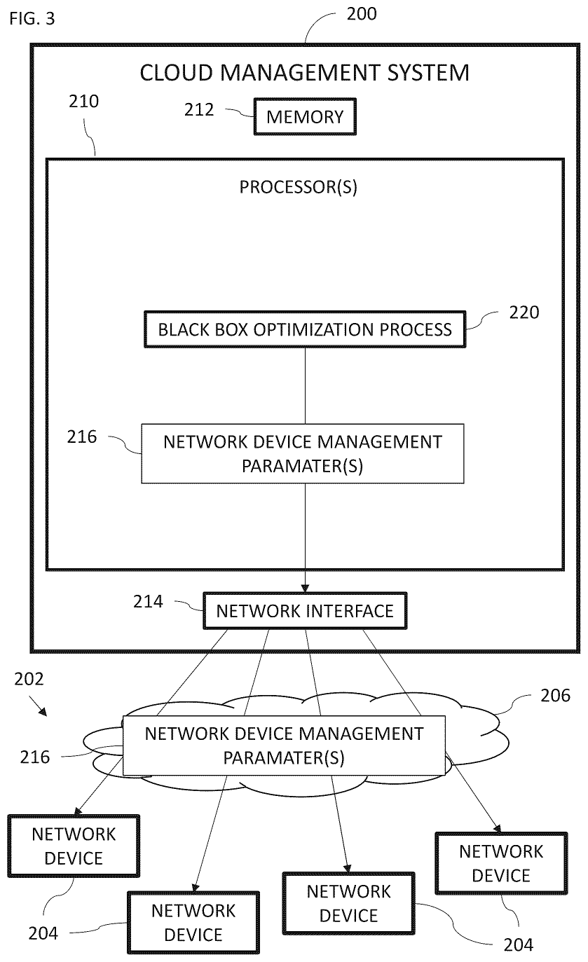

Reference is now made to FIGS. 2 and 3, which are block diagram views of a cloud management system 200 constructed and operative in accordance with an embodiment of the present disclosure. The cloud management system 200 may be implemented as part of the computing system 100 of FIG. 1 or as part of any suitable cloud infrastructure. FIGS. 2 and 3 show a cloud infrastructure 202 including network devices 204 and a network 206. The network devices 204 may include one or more network switches, and NICs, and/or DPUs.

The cloud infrastructure 202 also includes processing devices (not shown) directly connected to, or indirectly connected to network devices 204. The processing devices may include one or more CPUs, GPUs and/or DPUs. The DPU provides processing functionality as well as network device functionality. In other words, one or more of the network devices 204 may be a DPU.

As previously mentioned, customer data and logs of the different tenants in the cloud infrastructure 202 are generally not accessible to the cloud management system 200 in order for the cloud management system 200 to intelligently configure different network device parameters in the network 206, in order to improve network performance with respect to cyclic workloads executed by the different tenants. The processing devices such as servers (not shown) or other devices (not shown) process data of the cyclic workloads. The processing devices may process more than one job (e.g., parallel computing job). Each job may include all, or a subset, of the processing devices processing data and then sending the processed data over network 206 for further processing by the processing devices, or subset thereof. In a single cycle, data is processed and then shared across the network 206. The job includes multiple cycles of a processing phase and a communication phase of sharing data across the network 206.

In order to assess the performance of the network 206, high-frequency telemetry data is generated by each network device 204, which samples the packets of the different cyclic workloads yielding high-frequency telemetry (HFT) data 208. For example, each network device 204 may sample packets of the different cyclic workloads, and every time a packet is sampled, a timestamp is also sampled by the network devices 204, thereby generating telemetry data for that network device 204 indicative of a count of packets processed by that network device 204 for the different workloads according to time. The frequency of the sampling of the packets may be assigned any suitable value. The frequency of sampling is high enough to count enough packets, in order to provide sufficient data to derive the period metric (e.g., cycle time) for each of the workloads. By way of example only, the frequency of sampling may be in the range of 1 to 1000 samples per 100 milliseconds. The HFT data 208 may also be further categorized by the processing device(s) from which the packets were sent (i.e., processed), and/or to which the packets were sent (i.e., for processing).

The cloud management system 200 is configured to manage cloud infrastructure performance for cyclical workloads processed in cloud infrastructure 202. The cloud management system 200 includes one or more processors 210, a memory 212, a network interface 214. The network interface 214 is configured to share data with the network devices 204 for example, to receive HFT data 208 from network devices 204 (as shown in FIG. 2) and provide one or more network device management parameters 216 to network devices 204 (as shown in FIG. 3). The memory 212 is configured to store data used by the processor(s) 210.

The processor(s) 210 is configured to collect HFT data 208 from the network devices 204 in the cloud infrastructure 202. The HFT data 208 includes packet flow information related to cyclical workloads. For example, HFT data 208 may indicate the number of packets processed by network devices 204 and/or processing devices per time period and per workflow. As previously mentioned, the HFT data 208 may be collected by the processor(s) 210 and network devices 204, without accessing customer data or customer logs as the source of the HFT data 208 is based on packets transferred between the processing devices by network devices 204. The cyclic workloads may include any suitable cyclic workloads such as artificial intelligence (AI) training workloads. The length of the cycle of the cyclic workloads may change over time due to how long the data of each cycle takes to be processed by the relevant processing devices and how long the data takes to be shared over the network 206, e.g., due to network congestion.

The processor(s) 210 are configured to execute an HFT data analysis process 218 and a black-box optimization process 220.

The HFT data analysis process 218 is configured to analyze the HFT data 208 to extract period metric values 222 for the workloads. For example, the HFT data analysis process 218 may compute a period metric for workload A, and another period metric for workload B, and so on. The period metric may be a cycle length of a workload, for example, between transmissions of data, i.e., between adjacent transmission phases, between network devices 204 in cloud infrastructure 202. The period metric may also be defined as the length of time between adjacent processing phases. The period metric may be computed by analyzing the HFT data 208 for a given workload, and identifying the times when data is being transmitted by network devices 204 and from the identified times, deriving the times between successive transmission periods in order find the cycle length. The cycle length of the different identified periods may be different due to different processing and network conditions. The different cycle lengths may be averaged to compute a cycle length for a given workload. The period metric may be computed using any suitable method, for example, using an autocorrelation function.

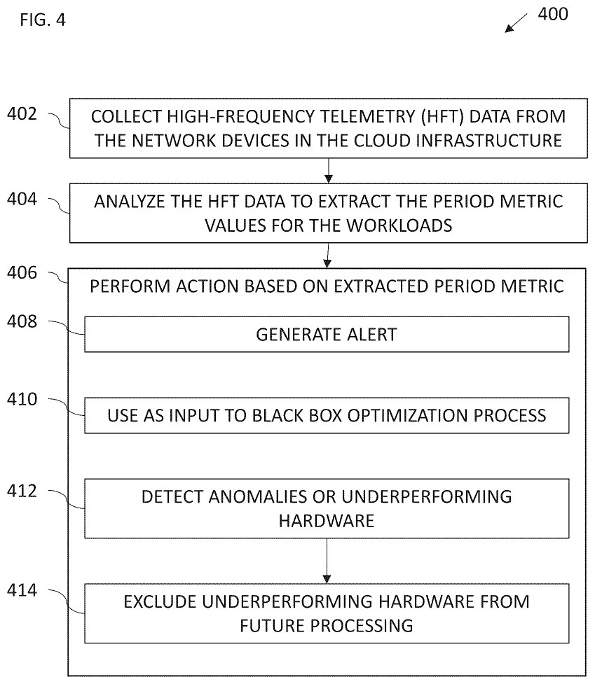

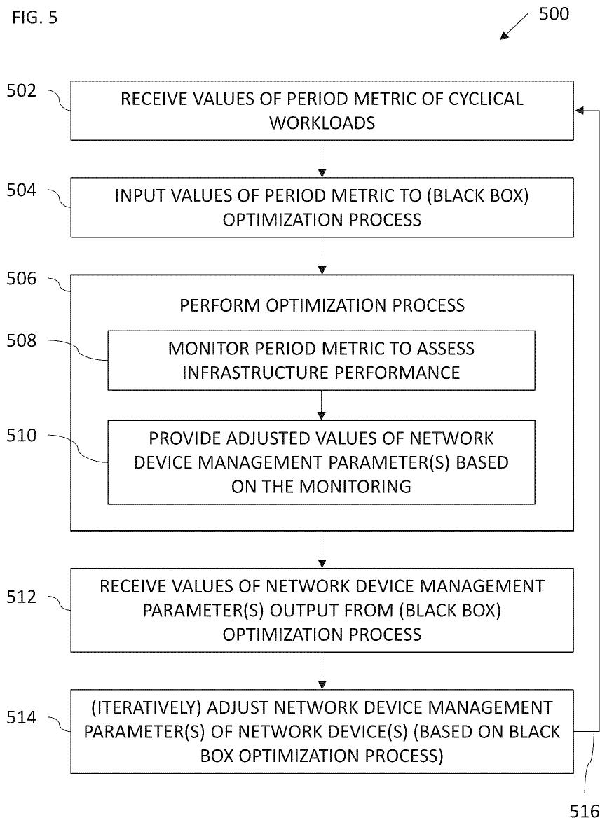

The extracted period metric values 222 may be used to perform an action (block 224) such as provide an alert or detect anomalies or underperforming hardware (described in more detail with reference to FIG. 4) or be provided to black-box optimization process 220 to optimize network device management parameter(s) 216, described in more detail below and with reference to FIG. 5.

The black-box optimization process 220 is configured to receive period metric values 222 of the cyclical workloads (based on HFT data 208 collected by network devices 204) in the cloud infrastructure 202, and provide adjusted network device management parameter(s) 216 based on period metric values 222. The adjusted network device management parameter(s) 216 are provided to network devices 204 (shown in FIG. 3) thereby causing changes to the processing of the cyclical workloads in the cloud infrastructure. For example, one of the network device management parameters 216 that may be changed is flow priorities. Changing the priorities of the network flows of the associated workflows may lead to the data of the workflows being transmitted over network 206 at different, non-conflicting, times, thereby leading to less network congestion and shorter workflow cycle times for one or more of the workflows. The black-box optimization process 220 may be configured to monitor the period metrics of the workflows to assess infrastructure performance and provide iteratively adjusted network device management parameter(s) 216 based on the monitoring of the period metrics of the workflows, thereby leading to improved performance of the workloads measured in terms of the cycle times. The network device management parameter(s) 216 may include any one or more of the following: adaptive routing configurations; congestion control settings; and/or Quality of Service (QOS) priorities.

The HFT data analysis process 218 and/or the black-box optimization process 220 may be executed by processors on one device such as an orchestrator device or on more than one device, for example, by one or more of network devices 204. For example, HFT data 208 associated with one of the network devices 204 may be pre-processed by the network device 204 that sampled that HFT data 208 and then the pre-processed data is sent to one or more devices to complete the processing and determine the period metrics of the workloads.

Reference is now made to FIG. 4, which is a flowchart 400 including steps in a period metric extraction method for use in the system 200 of FIG. 2. The processor(s) 210 is configured to collect HFT data 208 over network 206 from the network devices 204 and sampled by the network devices 204 in the cloud infrastructure 202 (block 402). The HFT data analysis process 218 running on the processor(s) 210 is configured to analyze the HFT data 208 to extract the period metric values 222 for the workloads (block 404). The processor(s) 210 is configured to perform an action based on the extracted period metric values 222 (block 406).

In some embodiments, the processor(s) 210 is configured to generate an alert based on one or more of the extracted period metric values 222 (block 408). For example, a change in value of the periodic metric for a given workload, such as a given deviation from the expected cycle length or average cycle length for the given workload, may trigger an alert to a systems administrator indicating potential performance degradation.

In some embodiments, the processor(s) 210 is configured to use the period metric values 222 as input to black-box optimization process 220 described in more detail with reference to FIG. 5 (block 410).

In some embodiments, the processor(s) 210 is configured to detect anomalies or underperforming hardware (e.g., processing devices such as GPUs in an AI cluster) based on the values of the period metric (block 412). The processor(s) 210 may be configured to exclude the underperforming hardware from future processing of the cyclic workloads (block 414). For example, if the cycle length of one or more workloads with respect to a given processing device or network device is below or above a given threshold, the processor(s) 210 may remove the given processing device or network device from processing workloads until the device is repaired.

Reference is now made to FIG. 5, which is a flowchart 500 including steps in a network device management parameter optimization method for use in the system 200 of FIG. 2. The processor(s) 210 is configured to receive period metric values 222 of the cyclical workloads based on data collected by network devices 204 in the cloud infrastructure 202 (block 502). The processor(s) 210 is configured to input period metric values 222 into black-box optimization process 220 (block 504). The processor(s) 210 is configured to perform an optimization process, e.g., black-box optimization process 220 (block 506). In some embodiments, any suitable optimization process may be used. The black-box optimization process 220 is configured to monitor the period metric values 222 to assess infrastructure performance (block 508), and provide adjusted values of network device management parameter(s) 216 based on the monitoring of the period metric values 222 (block 510). For example, if increasing a given network device management parameter 216 improved the period metric values 222, then the black-box optimization process 220 may increment the given network device management parameter 216 again and evaluate the change in period metric values 222, and so on, whereas if increasing a given network device management parameter 216 worsened the period metric values 222, then the black-box optimization process 220 may reduce the given network device management parameter 216 or alter a different network device management parameter 216 and evaluate the change in period metric values 222, and so on.

The processor(s) 210 is configured to receive the adjusted values of period metric values 222 from the black-box optimization process 220 (block 512), and adjust the network device management parameter(s) 216 used by the network devices 204 in the cloud infrastructure 202 based on the black box optimization process 220 (block 514). For example, the processor(s) 210 may be configured to send the adjusted network device management parameter(s) 216 to network devices 204 for the network devices 204 to self-adjust the way that the network devices 204 function. Therefore, the processor(s) 210 are configured to adjust network device management parameter(s) 216 of one or more of the network devices 204 based on the period metric values 222 causing changes to the processing of the cyclical workloads in the cloud infrastructure 202. The steps of blocks 500-514 are repeated (arrow 516) thereby causing the processor(s) 210 to iteratively adjust the network device management parameter(s) 216 based on the monitoring of the period metric values 222 and the black box optimization 220.

In practice, some or all of the functions of processor(s) 210 may be combined in a single physical component or, alternatively, implemented using multiple physical components. These physical components may comprise hard-wired or programmable devices, or a combination of the two. In some embodiments, at least some of the functions of the processor(s) 210 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

1. A system for managing cloud infrastructure performance for cyclical workloads processed in a cloud infrastructure, the system comprising:
at least one processor to:
receive values of a period metric of the cyclical workloads based on data collected by network devices in the cloud infrastructure, the period metric being a cycle length between transmissions of data; and
adjust at least one network device management parameter of at least one of the network devices based on the period metric values causing changes to the processing of the cyclical workloads in the cloud infrastructure; and
memory to store data used by the at least one processor.

2. The system according to claim 1, wherein the period metric is the cycle length between adjacent transmissions phases of a respective one of the cyclical workloads.

3. The system according to claim 1, wherein the at least one processor is to:
collect high-frequency telemetry (HFT) data from the network devices in the cloud infrastructure; and
analyze the HFT data to extract the period metric values for the workloads.

4. The system according to claim 3, wherein the HFT data includes packet flow information.

5. The system according to claim 3, wherein the HFT data is collected without accessing customer data or customer logs.

6. The system according to claim 3, wherein the at least one processor is to generate an alert based on at least one of the extracted period metric values.

7. The system according to claim 1, wherein the at least one processor is to:
use the period metric values as input to a black box optimization process;
adjust the at least one network device management parameter based on the black box optimization process;
monitor the period metric to assess infrastructure performance; and
iteratively adjust the at least one network device management parameter based on the monitoring of the period metric and the black box optimization.

8. The system according to claim 7, wherein the at least one network device management parameter includes any one or more of the following: adaptive routing configurations; congestion control settings; or Quality of Service (QOS) priorities.

9. The system according to claim 1, wherein the at least one processor is to detect anomalies or underperforming hardware based on the values of the period metric.

10. The system according to claim 9, wherein the at least one processor is to exclude the underperforming hardware from future processing of the cyclic workloads.

11. The system according to claim 1, wherein the cyclical workloads are artificial intelligence (AI) training workloads.

12. The system according to claim 1, wherein the network devices include network switches.

13. A system for managing cloud infrastructure processing cyclical workloads, the system comprising:
at least one processor to:
collect high-frequency telemetry (HFT) data from network devices in the cloud infrastructure; and
analyze the HFT data to extract values of a period metric for the workloads, the period metric being a cycle length between transmissions of data; and
a memory to store data used by the at least one processor.

14. The system according to claim 13, wherein the period metric is the cycle length between adjacent transmissions phases of a respective one of the cyclical workloads.

15. The system according to claim 13, wherein the at least one processor is to generate an alert based on at least one of the extracted period metric values.

16. The system according to claim 13, wherein the HFT data includes packet flow information.

17. The system according to claim 13, wherein the HFT data is collected without accessing customer data or customer logs.

18. The system according to claim 13, wherein the at least one processor is to:
use the period metric values as input to a black box optimization process;
adjust at least one network device management parameter based on the black box optimization process;
monitor the period metric to assess infrastructure performance; and
iteratively adjust the at least one network device management parameter based on the monitoring of the period metric and the black box optimization.

19. The system according to claim 18, wherein the at least one network device management parameter includes any one or more of the following: adaptive routing configurations; congestion control settings; or Quality of Service (QOS) priorities.

20. The system according to claim 13, wherein the at least one processor is to detect anomalies or underperforming hardware based on the values of the period metric.

21. The system according to claim 20, wherein the at least one processor is to exclude the underperforming hardware from future processing of the cyclic workloads.

22. The system according to claim 13, wherein the cyclical workloads are artificial intelligence (AI) training workloads.

23. The system according to claim 13, wherein the network devices include network switches.

24. A method for managing cloud infrastructure performance for cyclical workloads processed in a cloud infrastructure, the method comprising:
receiving values of a period metric of the cyclical workloads based on data collected by network devices in the cloud infrastructure, the period metric being a cycle length between transmissions of data; and
adjusting at least one network device management parameter of at least one of the network devices based on the period metric values causing changes to the processing of the cyclical workloads in the cloud infrastructure.

25. A method for managing cloud infrastructure processing cyclical workloads, the method comprising:
collecting high-frequency telemetry (HFT) data from network devices in the cloud infrastructure; and
analyzing the HFT data to extract values of a period metric for the workloads, the period metric being a cycle length between transmissions of data.
